(19) United States
(12) Patent Application Publication
(10) Pub. No.: US 2024/0370705 A1
(43) Pub. Date: Nov. 7, 2024

(54) INFORMATION-PRESERVING NEURAL NETWORK ARCHITECTURE

(71) Applicant: Robert Bosch GmbH, Stuttgart (DE)

(72) Inventors: Frank Schmidt, Leonberg (DE); Csaba Domokos, Simmozheim (DE); Kilian Rambach, Stuttgart (DE)

(21) Appl. No.: 18/649,928

(22) Filed: Apr. 29, 2024

(30) Foreign Application Priority Data
May 4, 2023 (DE) 10 2023 204 154.5

(51) Int. Cl. G06N 3/0464; G06N 3/084

(52) U.S. Cl. CPC G06N 3/0464; G06N 3/084

(57) ABSTRACT

A neural network architecture for processing measurement data. The neural network architecture includes a plurality of layers in each case with a plurality of neurons. Each neuron is designed to process complex-valued inputs with a holomorphic calculation function to produce an activation and to ascertain its output by applying a non-linear activation function to this activation. The activation function is also holomorphic.

### FIELD

The present invention relates to neural network architectures for the evaluation of measurement data, such as images or point clouds, which are generated in particular in the environmental monitoring of vehicles.

### BACKGROUND INFORMATION

For at least partially automated driving of vehicles or robots in road traffic or on company premises, constant monitoring of the environment of the vehicle or robot is indispensable. This type of environment monitoring collects records of measurement data, such as images or point clouds, and evaluates these records with a trained machine learning model with respect to a predefined task. Neural network architectures consisting of a plurality of layers are often used for this purpose. Typically, the measurement data is entered into an input layer and then passes through one or more intermediate layers before the result of the processing is output from an output layer.

If the measurement data is of complex value, a common approach is to process the real and imaginary parts of the respective measurement values, or also the magnitude and phase in a polar representation of the respective measurement values, as independent inputs to the neural network architecture.

### SUMMARY

The present invention provides a neural network architecture for processing measurement data. This network architecture comprises a number of layers, in each case with a number of neurons. The neurons can also be replaced by other processing units with substantially the same effect. For the sake of simplicity, only neurons are referred to below.

According to an example embodiment of the present invention, In the neural network architecture, for example, the outputs of layers can be routed as inputs to neighboring layers. Thus, input measurement data is initially processed in an input layer before the result is further processed in one or more intermediate layers and the final result of the processing is ascertained in an output layer. This final result is output from the neural network architecture.

Each neuron is designed to process complex-valued inputs with a holomorphic calculation function to produce an activation. The behavior of the neural network architecture is substantially characterized by trainable parameters of this calculation function. These parameters can comprise weights, for example, which are used to calculate the activation from the inputs fed to the neuron. Furthermore, the parameters can also comprise an additive bias, for example, which is included in the activation.

Each neuron is also designed to ascertain its output by applying a non-linear activation function to the activation obtained in this way. The activation function is also holomorphic.

It has been recognized that in this way the complete information content of complex-valued measurement data can be utilized, which includes not only the real and imaginary parts (or magnitude and phase) of a complex-valued variable, but also relationships between the real and imaginary parts, or between the magnitude and the phase. In particular, the training of the neural network architecture can also be carried out using this complete information content. During such training, the feedback regarding the output of the neural network is usually a value of a cost function (also known as a loss function). From this value of the cost function, so-called back propagation is used to ascertain gradients along which the trainable parameters of the neural network architecture should be sensibly changed in order to achieve an improvement in the value of the cost function with a high probability. This back propagation assumes that the processing of the measurement data or the training data used during training is carried out in a completely differentiable way. Now, by having complex differentiability, the aforementioned correlations between the real and imaginary parts can also be fully included in the ascertainment of the required gradients of the parameters.

This is illustrated by a simple example: For a damped harmonic oscillation, the deflection s as a function of time t is described by the complex-valued function

$$s = exp ( i \cdot ω \cdot t - δ \cdot t ) ,$$

where ω is the angular frequency and δ is the damping constant. In this notation with the complex exponential function, it is immediately apparent how a free oscillation with the angular frequency ω is modified by a damping term with the damping constant δ. However, if the real and imaginary parts of s are written in each case with the aid of real-valued trigonometric functions, this relationship is much less clear.

Even more relevant for the environmental monitoring of vehicles and robots mentioned at the beginning is an application in which the measurement data indicates a spatial and/or temporal distribution of at least one electromagnetic field. Maxwell's equations in particular, as the foundation of electrodynamics, are complex-valued, and complex-valued dynamics contain more information than the mere juxtaposition of real and imaginary parts.

The electromagnetic field can, for example, originate at least partially from reflections of electromagnetic interrogation radiation on one or more objects. This type of measurement data is generated, for example, if an environment is scanned for objects using radar or lidar radiation as interrogation radiation. The additional information that can be obtained through fully holomorphic processing can then, for example, result in greater accuracy in the subsequent determination of the position of objects and/or classification of the type of objects. For example, the complex-valued radar signal contains the Doppler spectrum across all physical and/or virtual antenna channels that were involved in receiving the signal, along with an azimuth spectrum of each radar pulse (chirp) emitted. Such spectra are particularly helpful in the detection and classification of objects. Virtual antenna channels exist, for example, if a “multiple input-multiple output” (MIMO) radar is used. Holomorphic processing is also advantageous, for example, with the precise ascertainment of the direction from which a radar or lidar reflex comes (direction of arrival, DOA), which is complicated by constantly changing ambient conditions and possible multipath propagation of the respective interrogation radiation.

The same applies to other radio applications in which the propagation of electromagnetic fields is preferably represented in complex-valued variables.

Regardless of the specific application, an advantage of a neural network architecture with a holomorphic activation function is that it generalizes better to inputs not seen during training than, for example, an architecture whose activation function processes the real and imaginary parts separately. This goes hand in hand with the fact that decision boundaries are smoothed in the input space of the neural network architecture. In particular, the occurrence of discontinuities, for example, which is favored by, for example, the use of a complex ReLU activation function, is suppressed.

In a particularly advantageous embodiment of the present invention, the activation function, and/or a differential of this activation function, is a conformal mapping. If two complex numbers z₁ and z₂ that include an intermediate angle in the complex plane are fed to this conformal mapping, the results provided by the conformal mapping include the same intermediate angle in the complex plane. Furthermore, a length ratio between the complex numbers z₁ and z₂ can also remain preserved between the results provided by the conformal mapping. Although the conformal mapping changes the long-range order in the complex plane, at least a certain short-range order is preserved. In particular, representations of features that are orthogonal to one another also remain orthogonal to one another after applying the conformal mapping. Orthogonality is a relationship between features that embodies particularly important information. If, on the other hand, the mapping is not a conformal mapping, the aforementioned representations can produce results that are very close to one another and can no longer be distinguished from one another numerically.

In another particularly advantageous embodiment of the present invention, the activation function includes a Möbius transformation of the form

$$f ( z ) = \frac{a \cdot z + b}{c \cdot z + d}$$

with free coefficients a, b, c, d. These coefficients can also be trained, for example, when training the neural network architecture. In this way, the transformation that provides the best result with respect to the overall object to be achieved by the neural network architecture can be found within the parameterized approach. Conventional, common activation functions, such as ReLU, Sigmoid and tanh, have no such degree of freedom and therefore cannot be adapted to a specific object to be achieved. Training the coefficients is much easier to motivate than selecting a specific activation function from a catalog of available functions.

Particularly advantageously, the coefficients a, b, c, d of the Möbius transformation are real-valued. This significantly reduces the search area. At the same time, it is ensured that the positive imaginary half-plane is mapped onto itself. Furthermore, the probability that the output of the neural network architecture “collapses” onto the real-valued axis is reduced.

In another particularly advantageous embodiment of the present invention, the matrix

$$A = ( \begin{matrix}a & b \\ c & d\end{matrix} )$$

of the coefficients of the Möbius transformation has a determinant det(A), which deviates from a predefined value by at most a predefined amount. For example, det(A) can be held around the value 1 in a circular graph in the complex plane with radius

$$\frac{1}{2} .$$

In this way, it is ensured, for example, that the matrix A does not become singular. For example, in particular, det(A) can be checked for each training step that changes the matrix A. As will be explained later, if the determinant det(A) deviates too much, all elements of A can be divided by the root \sqrt{det(A)} of the determinant det(A).

The neural network architecture can, for example, be designed as a feature extractor. Outputs from neurons in different layers of the feature extractor then indicate the expression of features of different scales and/or complexities in the measurement data. An example of a feature extractor is a convolutional neural network (CNN), which generates feature maps by smoothly applying filter kernels to the measurement data. The part of the feature map generated by applying a filter kernel to the measurement data is also called the “channel” of the feature map corresponding to this filter kernel, i.e. the feature map is a stack of such channels.

In a further particularly advantageous embodiment of the present invention, the neural network architecture comprises a task head, which is designed to ascertain a solution to a predefined task with respect to the measurement data from one or more outputs of the feature extractor. The architecture of the task head is adapted to the predefined task. If the task head is changed after training the neural network architecture, it may be sufficient to train only the new task head. On the other hand, the feature extractor can, for example, only undergo a shortened further training (“fine tuning”) or be completely frozen in its previous trained state. The task head can, for example, provide a real-valued result. For example, it can initially receive a complex-valued output from the feature extractor and therefore still draw on the full information content. This information is then condensed into the solution with respect to the predefined task and at the same time transferred to the real-valued axis.

In particular, the task head can be designed, for example, to ascertain classification scores with regard to one or more classes of a predefined classification for the measurement data. For example, the task head can classify types of objects whose presence is indicated by the measurement data.

In a further particularly advantageous embodiment of the present invention, a control signal is formed from one or more outputs provided by the neural network architecture. A vehicle, a driver assistance system, a robot, a quality control system, a system for monitoring regions and/or a system for medical imaging is controlled with the control signal. In this way, the probability is increased that the reaction executed by the corresponding technical system in response to the control signal is appropriate in the situation embodied by the measurement data.

The present invention also relates to a method for training the neural network architecture described above.

Training records of measurement data are provided within the framework of this method. These training records can, for example, be annotated (labeled) with target outputs for a monitored training course.

Here, the term “record” denotes a data set of associated data, comparable to the information on a card in a card index box. A record can be, for example, values of a plurality of measured variables which jointly characterize an operating state of a technical system, or even be image data and possibly associated metadata. Here, the term “record” is used instead of “data set,” since the term “data set” has already been taken over in the technical language of machine learning and designates the collection of all records, comparable to the card index box that contains all index cards.

The training records are fed to the neural network architecture to be trained and processed by this neural network architecture into outputs. These outputs are valued using a predefined real-valued cost function. For example, a deviation of outputs from target outputs can be measured during monitored training. However, a feature extractor can also be trained in a self-monitored manner, for example together with a decoder that attempts to reconstruct the original input from the output of the feature extractor.

Parameters that characterize the behavior of the neural network architecture are optimized with the aim of improving the valuing by the cost function during further processing of training records. These parameters comprise not only the usual adjustment screws of neural networks, such as weights and a bias value for calculating inputs to produce an activation of a neuron, but also free coefficients of a parameterized approach for the holomorphic activation function. Thus, these coefficients can be summarized in a vector together with weights and bias values, for example. However, a vector with weights and bias values, on the one hand, and a vector with coefficients, on the other hand, can also be updated alternately in one training step, for example. The gradients in each case are then more meaningful on their own with regard to the specific application than a gradient in a “mixed” space.

As explained above, this creates great flexibility with regard to the selection of the activation function. From the large class of functions that the parameterized approach allows, the one that is best suited to achieve the ultimate goal of the neural network architecture is selected. This selection is then automatically better motivated than a manual selection of an activation function, for example. The previously introduced class of Möbius transformations, for example, can be selected as a parameterized approach.

In a particularly advantageous embodiment of the present invention, within the framework of optimization, it is checked whether the deviation of the determinant det(A) of a matrix A formed from the coefficients of the parameterized approach for the holomorphic activation function from a predefined value exceeds a predefined amount. If this is the case, the elements of this matrix are divided by the root \sqrt{det(A)} of the determinant det(A). In this way, for example, it is possible to prevent the matrix A from becoming singular and the activation function from becoming trivial.

The neural network architecture can, for example, be computer-implemented. Therefore, the invention also relates to a computer program comprising machine-readable instructions which, when executed on one or more computers, cause the computer or computers to realize at least one instance of the neural network architecture described above. In this connection, graphics processors, GPUs, control devices for vehicles or embedded systems for installation in other devices, which are also in each case capable of executing machine-readable instructions, are also to be regarded as computers.

The present invention also relates to a machine-readable data carrier and/or a download product comprising the one or more computer programs. A download product is a digital product that can be transmitted via a data network, i.e., can be downloaded by a user of the data network, and can, for example, be offered for immediate download in an online shop.

Furthermore, one or more computers and/or compute instances can be equipped with the one or more computer programs, with the machine-readable data carrier or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the neural network architecture 1 according to the present invention.

FIG. 2 show an exemplary use of the output 1c of the neural network architecture 1 according to the present invention.

FIG. 3 shows an exemplary embodiment of the method 100 for training the neural network architecture 1 according to the present invention.

FIGS. 4A-4C show a comparison of the behavior of network architectures 1 trained with the same training data (FIG. 4A) with a non-holomorphic activation function (FIG. 4B) and with a holomorphic activation function 7 (FIG. 4C).

### DETAILED DESCRIPTION OF EXAMPLE EMBODIMENTS

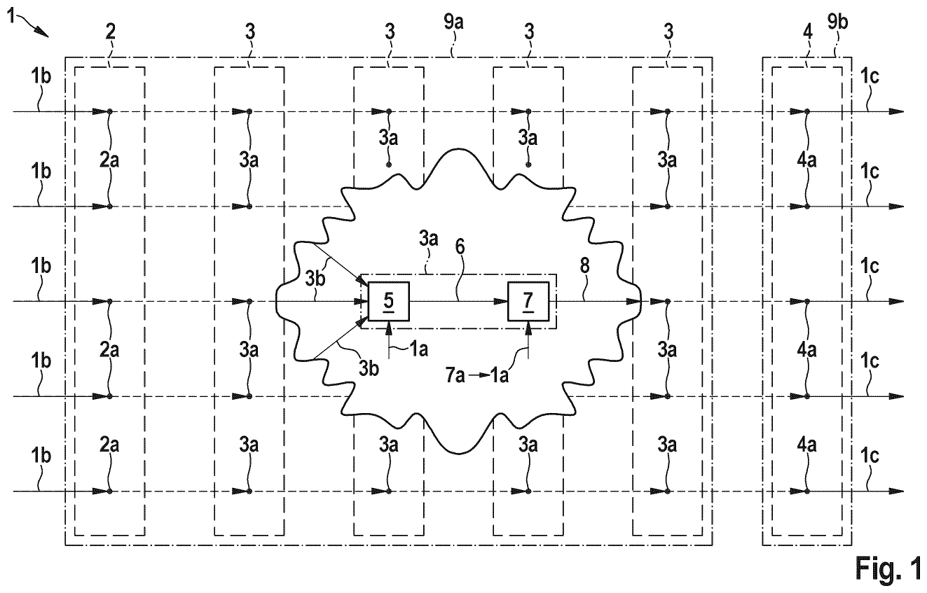

FIG. 1 is a schematic drawing of an exemplary embodiment of the neural network architecture 1. The neural network architecture 1 comprises an input layer 2 with neurons 2a, which receives measurement data 1b as inputs. This measurement data is then successively further processed in a plurality of intermediate layers 3 with neurons 3a. The input layer 2 and the intermediate layers 3 together form a feature extractor 9a.

The neural network architecture 1 also comprises an output layer 4. This processes the output of the feature extractor 9a to produce the final result 1c provided by the neural network architecture 1 as a whole with respect to the task to be achieved. Thus, the output layer 4 also serves as the task head 9b, which further processes the output of the feature extractor 9a.

The center of FIG. 1 shows by way of example how processing takes place within a neuron 3a in an intermediate layer 3. The inputs 3b fed to the neuron 3a are processed to produce an activation 6 using a holomorphic calculation function, here: a weighted sum. The weights of this sum and an optional additive bias value, which is added to the activation 6, belong to the parameters 1a, which characterize the behavior of the neural network architecture 1. The activation 6 is processed by a holomorphic, non-linear activation function 7 to produce the output 8 of the neuron 3a. In the example shown in FIG. 1, a parameterized approach with free coefficients 7a is selected for the non-linear activation function 7. Thus, these coefficients 7a also become parameters 1a that characterize the behavior of the neural network architecture 1.

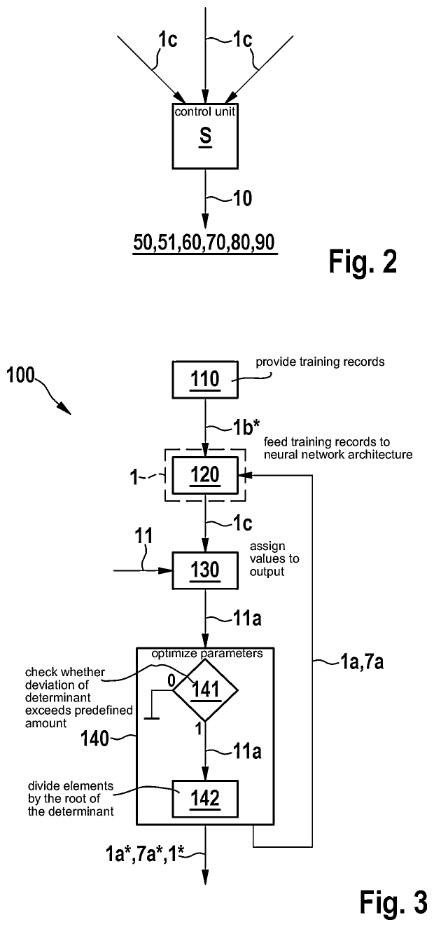

FIG. 2 shows by way of example how the output 1c provided by the neural network architecture 1 can be further utilized. A control unit S receives the output 1c of the neural network architecture 1 and ascertains a control signal 10. This control signal 10 is used to control a vehicle 50, a driver assistance system 51, a robot 60, a system 70 for quality control, a system 80 for monitoring regions and/or a system 90 for medical imaging.

FIG. 3 is a schematic flowchart of an exemplary embodiment of the method 100 for training the neural network architecture 1 described above.

In step 110, training records 1b* of measurement data 1b are provided. These training records 1b* are fed to the neural network architecture 1 in step 120 and processed by the neural network architecture 1 into outputs 1c. The outputs 1c obtained in this way are assigned values in step 130 using a predefined real-valued cost function 11. A valuation 11a is created.

In step 140, parameters 1a characterizing the behavior of the neural network architecture 1 are optimized with the aim of improving the valuation 11a by the cost function 11 upon further processing of training records 1b. These parameters 1a also comprise free coefficients 7a of a parameterized approach for the holomorphic activation function 7. The fully optimized state of parameters 1a and 7a is designated by the reference signs 1a* or 7a*. These parameters 1a, 7a also specify the fully trained state 1* of the neural network architecture 1.

According to block 141, within the framework of this optimization, for example, it can be checked whether the deviation of the determinant det(A) of a matrix A formed from the coefficients of the parameterized approach for the holomorphic activation function from a predefined value exceeds a predefined amount. If this is the case (truth value 1), the elements of this matrix can be divided by the root \sqrt{det(A)} of the determinant det(A) according to block 142.

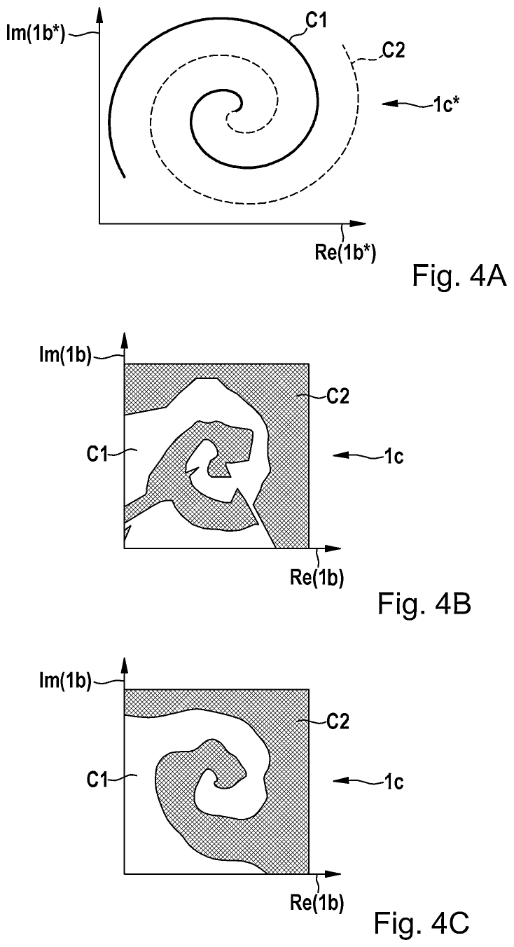

FIGS. 4A-4C illustrates how the change from a non-holomorphic activation function to a holomorphic activation function affects the training of a neural network architecture 1 based on the same training data. In the example shown in FIGS. 4A-4C, the neural network architecture 1 is a binary classifier that assigns an input 1b consisting of a single complex number to one of two possible classes C1 and C2.

FIG. 4A shows the records 1b* of training data. For each record 1b*, in each case the imaginary part Im(1b*) is plotted against the real part Re(1b*). The records 1b* on the curve C1 are labeled with class C1 as target outputs. The records 1b* on the curve C2 are labeled with class C2 as target outputs.

FIG. 4B shows, for exemplary measurement data 1b in the plane spanned by its real part Re(1b) and imaginary part (1b), which class the neural network architecture trained with the records 4b* shown in FIG. 4A assigns to this measurement data 1b as output 1c in each case. Here, the activation function is the non-holomorphic complex ReLU function. The lack of complex differentiability is noticeable here in the form of sharp corners and discontinuities at the decision boundary between classes C1 and C2.

In comparison, FIG. 4C shows the effect of switching to the holomorphic Möbius transformation

$$f ( z ) = 1 - \frac{1}{z}$$

as the activation function 7. It is clearly recognizable that the decision boundary between classes C1 and C2 is now much smoother. Sharp corners and discontinuities have completely disappeared. This also makes the neural network architecture 1 more robust in the sense that small changes in the measurement data 1b are less likely to result in large changes in the output 1c.

1-16. (canceled)

17. A neural network architecture for processing measurement data, comprising:
a plurality of layers, each having a plurality of neurons, wherein each of the neurons is configured to process complex-valued inputs with a holomorphic calculation function to produce an activation and to ascertain an output of the activation by applying a non-linear activation function to the activation, wherein the activation function is also holomorphic.

18. The neural network architecture according to claim 17, wherein the activation function, and/or a differential of the activation function, is a conformal mapping, after application of which to two complex numbers z₁ and z₂ the intermediate angle between the two complex numbers z₁ and z₂ is preserved in a complex plane.

19. The neural network architecture according to claim 18, wherein the activation function includes a Möbius transformation of the form
$$f ( z ) = \frac{a \cdot z + b}{c \cdot z + d}$$
with free coefficients a, b, c, d.

20. The neural network architecture according to claim 19, wherein the coefficients a, b, c, d of the Möbius transformation are real-valued.

21. The neural network architecture according to claim 20, wherein a matrix
$$A = ( \begin{matrix}a & b \\ c & d\end{matrix} )$$
of coefficients of the Möbius transformation has a determinant, which deviates from a predefined value by at most a predefined amount.

22. The neural network architecture according to claim 17, wherein the neural network architecture is at least partially formed as a feature extractor, wherein outputs of neurons in different layers of the feature extractor indicate an expression of features of different scales and/or complexities in the measurement data.

23. The neural network architecture according to claim 22, further comprising:
a task head that is configured to ascertain a solution of a predefined task from one or more outputs of the feature extractor with respect to the measurement data.

24. The neural network architecture according to claim 23, wherein the task head is configured to ascertain classification scores with regard to one or more classes of a predefined classification for the measurement data.

25. The neural network architecture according to claim 17, wherein the neural network architecture is configured to process measurement data that indicates a spatial and/or temporal distribution of at least one electromagnetic field.

26. The neural network architecture according to claim 25, wherein the electromagnetic field originates at least partially from reflections of an electromagnetic interrogation radiation on one or more objects.

27. The neural network as recited in claim 25, wherein an actuation signal is formed from one or more outputs provided by the neural network architecture, and a vehicle, and/or a driver assistance system, and/or a robot, and/or a system for quality control, and/or a system for monitoring regions, and/or a system for medical imaging, is controlled with the control signal.

28. A method for training a neural network architecture, the neural network architecture including for processing measurement data, including a plurality of layers, each having a plurality of neurons, wherein each of the neurons is configured to process complex-valued inputs with a holomorphic calculation function to produce an activation and to ascertain an output of the activation by applying a non-linear activation function to the activation, wherein the activation function is also holomorphic, the method comprising the following steps:
providing training records of measurement data;
feeding the training records to the neural network architecture, and processing the training records by the neural network architecture into outputs;
valuing the outputs using a predefined real-valued cost function; and
optimizing parameters that characterize a behavior of the neural network architecture with an aim of improving the valuation by the cost function during further processing of training records, wherein the parameters also include free coefficients of a parameterized approach for the holomorphic activation function.

29. The method according to claim 28, wherein within a framework of the optimization:
it is checked whether a deviation of a determinant of a matrix A formed from coefficients of a parameterized approach for the holomorphic activation function from a predefined value exceeds a predefined amount, and
based on the deviation exceeding the predefined amount, elements of the matrix are divided by a root det(A) of the determinant det(A).

30. A non-transitory machine-readable data carrier on which is stored a computer program containing machine-readable instructions, the machine readable instructions, when executed by one or more computers, causing the one or more computer to realize an instance of a neural network architecture, the neural network architecture being for processing measurement data, the neural network architecture comprising:
a plurality of layers, each having a plurality of neurons, wherein each of the neurons is configured to process complex-valued inputs with a holomorphic calculation function to produce an activation and to ascertain an output of the activation by applying a non-linear activation function to the activation, wherein the activation function is also holomorphic.

31. One or more computers comprising a non-transitory machine-readable data carrier on which is stored a computer program containing machine-readable instructions, the machine readable instructions, when executed by the one or more computers, causing the one or more computer to realize an instance of a neural network architecture, the neural network architecture being for processing measurement data, the neural network architecture comprising:
a plurality of layers, each having a plurality of neurons, wherein each of the neurons is configured to process complex-valued inputs with a holomorphic calculation function to produce an activation and to ascertain an output of the activation by applying a non-linear activation function to the activation, wherein the activation function is also holomorphic
